(19) United States
(12) Patent Application Publication
(10) Pub. No.: US 2010/0262588 A1
(43) Pub. Date: Oct. 14, 2010

(54) METHOD OF ACCESSING A MEMORY

(75) Inventor: Yu-Liang SUN, TAIPEI CITY (TW)

Correspondence Address: BRIAN M. MCINNIS, 12th Floor, Ruttonjee House, 11 Duddell Street, Hong Kong, HK

(73) Assignee: INVENTEC CORPORATION, TAIPEI CITY (TW)

(21) Appl. No.: 12/482,428

(22) Filed: Jun. 10, 2009

(30) Foreign Application Priority Data
Apr. 14, 2009 (TW) 98112319

(51) Int. Cl. G06F 7/00; G06F 12/02

(52) U.S. Cl. 707/693; 711/170; 711/154; 707/E17.044; 711/E12.001; 711/E12.002

(57) ABSTRACT

A method of accessing a memory is implemented on a memory system having a main memory and a secondary memory. The main memory includes a compressed data area that has a SWAP file zone predefined therein. When the main memory is insufficient for data buffering, the predefined SWAP file zone is provided for data swapping. A newly defined SWAP file zone is dynamically created in the compressed data area whenever each last defined SWAP file zone is insufficient for data swapping, and the secondary memory is substitute for data swapping only when the compressed data area has insufficient capacity.

### RELATED APPLICATIONS

This application claims priority to Taiwan Application Serial Number 98112319, filed Apr. 14, 2009, which is herein incorporated by reference.

### FIELD OF THE INVENTION

This invention relates generally to a method of using a memory, and more particularly, to a method of using a compressed-type memory.

### BACKGROUND OF THE INVENTION

As the physical memory (RAM) of the recent memory system is used up, and the memory system requires more memory resource, the inactive page of the physical memory will be moved to a predefined SWAP data space. Although the SWAP data space can facilitate the memory system to increase some memory capacity, it cannot be considered as a substitute of the memory. Conventionally, the SWAP data space is configured in the hard disk, and if has lower speed than the physical memory.

However, the memory system having less physical memory capacity often utilizes the SWAP data space for storing the memory data. For the purposes of keeping itself operating performance of the memory system, in light of the current stage, to increase the physical memory with more capacity seems to be an inevitable solution to enhance the operating performance of the memory system

### SUMMARY OF THE INVENTION

Accordingly, it is an aspect of the present invention to provide a method of accessing a memory, which can provide a user with a flexibly alternative solution of an operating performance between the original one of the physical memory and the lower one of the SWAP file space of the hard disk before the user obtains another physical memory with larger capacity. Thereby, this alternative solution is beneficially provided with higher operating performance than the way to use the SWAP file space of the hard disk, instead of spending facility cost on additional physical memories.

According to an embodiment of the present invention, the method of accessing the memory may be implemented on a memory system. The memory system has a main memory and a secondary memory, in which the main memory is divided into a primary work area and a compressed data area both in a respectively fixed capacity. The compressed date area has a SWAP file zone predefined therein. The method may include the following steps. The memory is prioritized in a using sequence of the primary work area, the compressed data area and the secondary memory. When the primary work area is insufficient for data buffering, a compressed data is stored in the predefined SWAP file zone of the compressed data area. A newly defined SWAP file zone is created in the compressed data area for storing the compressed data when the predefined SWAP file zone of the compressed data area has insufficient capacity for data swapping. Another newly defined SWAP file zone is dynamically created in the compressed data area whenever each last defined SWAP file zone has insufficient capacity for data swapping, and the secondary memory is utilized for data swapping only when the compressed data area has insufficient capacity.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 depicts a block diagram of a memory system according to an embodiment of the present invention.

FIG. 2 depicts a flowchart of a method of accessing a memory according to an embodiment of the present invention.

### DETAILED DESCRIPTION OF THE PREFERRED EMBODIMENT

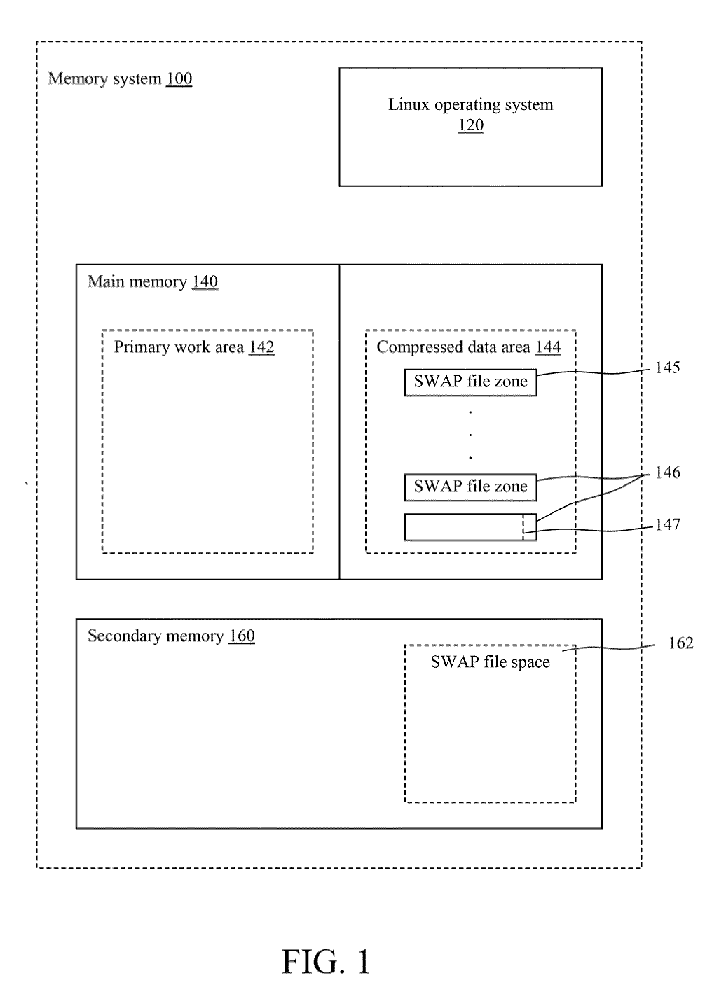

The present invention is directed to a method of accessing a memory. Reference is made to FIG. 1, which depicts a block diagram of a memory system according to an embodiment of the present invention. In brief, the method is implemented on a main memory 140, which is divided into a primary work area 142 and a compressed data area 144. A SWAP file zone 145 is predefined in the compressed data area 144. When the primary work area 142 is insufficient for data buffering, the temporary data in the primary work area 142 is compressed to be a compressed data, and the compressed data is stored in the predefined SWAP file zone 145 of the compressed data area 144. When there is insufficient space in the predefined SWAP file zone for storing the compressed data, a newly defined SWAP file zone 146 is dynamically created in the compressed data area 144 until the compressed data area 144 has insufficient capacity.

In an embodiment of the present invention, the method is implemented on a memory system 100. Reference is made to FIG. 1 again, which depicts a block diagram of a memory system 100 according to an embodiment of the present invention. The memory system 100 may be, for example, a thin client or a server, which is mainly based on LINUX operating system 120. The memory system 100 may have a main memory 140 (also referred as a physical memory such as a volatile memory or RAM) and a secondary memory 160 (also referred as a second memory such as a non-volatile memory, hard disk or flash). The main memory 140 is divided into a primary work area 142 and a compressed data area 144 with a predefined capacity ratio (such as 1:1, 2:1 or the like). The primary work area 142 of the main memory 140 is a preset area where the data is temporarily stored. The compressed data area 144 is not preset for any SWAP data zone 145 before boost.

In this embodiment, the main memory 140 is 512 MB, for example, in which the primary work area 142 and the compressed data area 144 is both predefined in 256 MB. In general, the compressed data area 144 can be compressed to less than a half of uncompressed capacity (i.e. 2 or more of compression ratio), so that the primary work area 142 (256 MB) plus the compressed data area 144 (256 MB×2) provides an available 756 MB capacity more than the main memory 140 having 512 MB capacity.

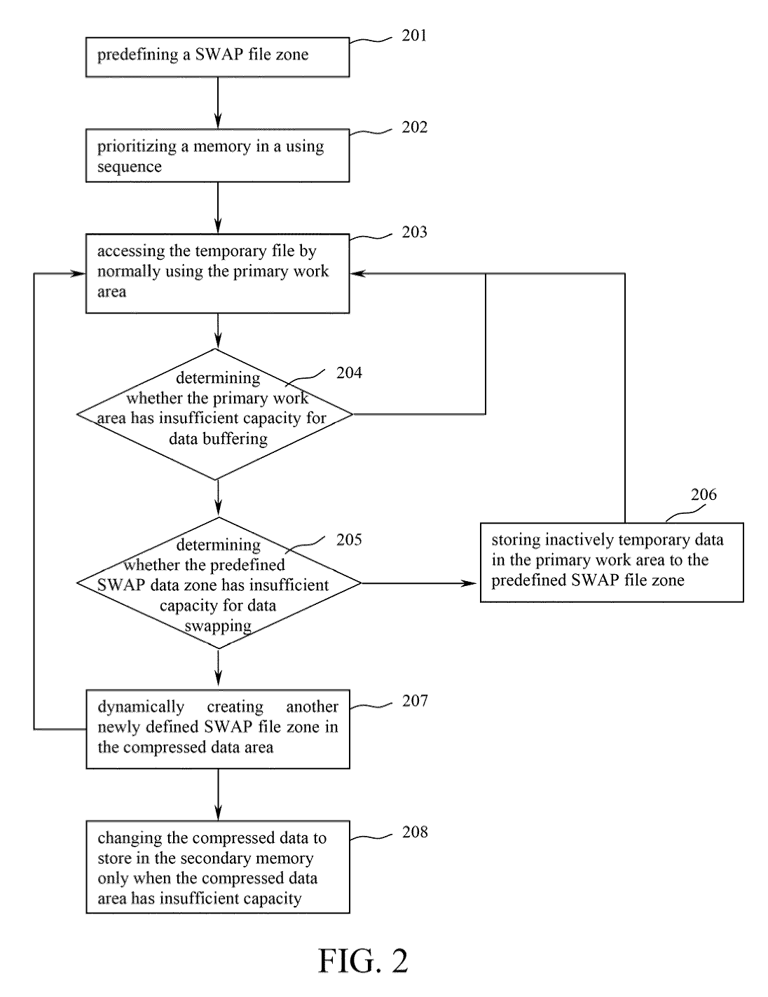

Reference is made to FIGS. 1 and 2, in which FIG. 2 depicts a flowchart of a method of accessing a memory 100 according to an embodiment of the present invention, and the method may include the following steps.

In the step 201, when the memory system 100 is boosted, at least one (not limited to only one) SWAP file zone 145 (for example, RAM DISK) may be predefined in the compressed data area 144 by the LINUX operating system. When there are several predefined SWAP file zones 145, they may be not limited to have the same capacity. In this embodiment, the predefined SWAP file zones 145 may have 8 MB capacity.

In the step 202, the memory system 100 is prioritized in a using sequence of the primary work area 142, the compressed data area 144 and the secondary memory 160, so that the LINUX operating system 120 can access the temporary data according to the aforementioned prioritized sequence.

In the step 203, when the memory system 100 normally operates, the LINUX operating system 120 can access the temporary data in the primary work area 142 of the main memory 140.

In the step 204, the LINUX operating system 120 can monitor the capacity of the primary work area 142 and determine whether the primary work area 142 has insufficient capacity for data buffering. The LINUX operating system 120 can proceed with the step 205 if the primary work area 142 has sufficient capacity; otherwise, it returns to the step 203.

In the step 205, the LINUX operating system 120 can monitor the capacity of the predefined SWAP file zone 145 of the compressed data area 144 and determine whether the predefined SWAP file zone 145 has insufficient capacity for data swapping. The LINUX operating system 120 can proceed with the step 207 if the capacity of the predefined SWAP file zone 145 has insufficient capacity; otherwise, it returns to the step 206.

In the step 206, when the primary work area 142 has insufficient capacity for LINUX operating system 120 to store the temporary data, however, the predefined SWAP file zone 145 has sufficient capacity for the LINUX operating system 120 to do this, the memory system 100 can compress inactively temporary data in the aforementioned compression ratio, and store the compressed data to the predefined SWAP file zone 145 of the compressed data area 144, and proceeds the step 203 to release capacity of the primary work area 142 of the main memory 140 for accessing the temporary data.

In the step 207, when the primary work area 142 has insufficient capacity for storing the temporary data again, as well as the predefined SWAP file zone 145 of the compressed data area 144 having insufficient capacity for data swapping, another newly defined SWAP file zone 146 may be dynamically created in the compressed data area 144, for the LINUX operating system 120 to store the compressed data, and returns to the step 203. When the newly defined SWAP file zone 146 of the compressed data area 144 also have insufficient capacity for the memory system 100 to store the compressed data, processes to the step 208. By the way, the newly defined SWAP file zone 146 in the step 207 is not limited to have the same capacity with the predefined SWAP file zone 145.

In addition, when the temporary data stored in the predefined SWAP file zone 145 reaches to a preset threshold 147 (for example, the predefined SWAP file zone 145 has 8 MB capacity, and the preset threshold 147 may be set to 7.5 MB), the LINUX operating system 120 consider that the predefined SWAP file zone 145 of the compressed data area 144 is about to be insufficient for storing the compressed data.

In the step 208, until the compressed data area 144 has insufficient capacity for the LINUX operating system 120 to store the compressed data, the LINUX operating system 120 changes the inactively temporary data to store in the SWAP data space 162 of the secondary memory 160, so that the capacity of the primary work area 142 of the main memory 140 is released for accessing the temporary data.

Therefore, the present invention beneficially provides the memory temporary storage capacity more than the original capacity of the main memory, and the operating performance more than the SWAP data space of the secondary memory. Moreover, the present invention can delay the timing of the secondary memory being as the SWAP data space.

As is understood by a person skilled in the art, the foregoing embodiment of the present invention is illustrated of the present invention rather than limiting of the present invention. It is intended to cover various modifications and similar arrangements included within the spirit and scope of the appended claims. Therefore, the scope of which should be accorded to the broadest interpretation so as to encompass all such modifications and similar structure.

What is claimed is:

1. A method of accessing a memory applied in a memory system having a secondary memory and a main memory that is divided into a primary work area and a compressed data area, comprising:
predefining a SWAP file zone in the compressed data area;
storing a compressed data in the predefined SWAP file zone when the primary work area has insufficient capacity for data buffering;
creating a newly defined SWAP file zone in the compressed data area for storing the compressed data when the predefined SWAP file zone has insufficient capacity for data swapping; and
dynamically creating another newly defined SWAP file zone in the compressed data area for storing the compressed data whenever each last defined SWAP file zone has insufficient capacity for data swapping, and changing the compressed data to store in the secondary memory only when the compressed data area has insufficient capacity.

2. The method of accessing the memory according to claim 1, before the SWAP file zone is predefined in the compressed data area, further comprises:
prioritizing the memory in a using sequence of the primary work area, the compressed data area and the secondary memory.

3. The method of accessing the memory according to claim 1, wherein when free space excluding from the compressed data temporarily stored in the predefined SWAP file zone is less than a preset threshold of predefined SWAP file zone, the predefined SWAP file zone is considered that it is insufficient for storing the compressed data.

4. The method of accessing the memory according to claim 1, wherein the memory system is a thin client or a server.

5. The method of accessing the memory according to claim 1, wherein the memory system includes a LINUX operating system.

6. The method of accessing the memory according to claim 1, wherein the main memory is a volatile memory, and the secondary memory is a non-volatile memory.

7. The method of accessing the memory according to claim 1, wherein capacities of the primary work area and the compressed data area are predefined respectively when the memory system is boosted.

8. The method of accessing the memory according to claim 1, wherein a compression ratio of the compressed data area is 2 or more.

9. The method of accessing the memory according to claim 1, wherein the SWAP data areas have a fixed capacity.
